(19) United States
(12) Patent Application Publication
(10) Pub. No.: US 2009/0164506 A1
(43) Pub. Date: Jun. 25, 2009

(54) System and Method for Content-Based Email Authentication

(75) Inventors: David M. Barley, Torrance, CA (US); Ryuji J. Masuda, Santa Rosa Valley, CA (US)

Correspondence Address: WHITE & CASE LLP;PATENT DEPARTMENT, 1155 AVENUE OF THE AMERICAS, NEW YORK, NY, 10036, US

(73) Assignee: Casdex, Inc., Camarillo, CA (US)

(21) Appl. No.: 12/330,502

(22) Filed: Dec. 8, 2008

Related U.S. Application Data
(60) Provisional application No. 61/008,141, filed on Dec. 19, 2007.

(51) Int. Cl. G06F 17/30; G06F 15/16

(52) U.S. Cl. 707/102; 709/206; 707/E17.002

(57) ABSTRACT

One embodiment of a system for content-based email authentication includes an email server configured to receive an email from a client, a content identifier generator configured to generate content identifiers for an email by applying a hash algorithm to content of the email, the email server further configured to append the content identifiers to the email before sending the email. The email server is further configured to receive a second email from a network, the second email having appended content identifiers. The content identifier generator is further configured to generate content identifiers for the second email, and the email server is further configured to compare the generated content identifiers with the appended content identifiers and if the generated content identifiers and the appended content identifiers match, the email is deemed authentic and the email server is configured to send the second email to a client.

### CROSS-REFERENCE TO RELATED APPLICATION

This application claims the benefit of U.S. Provisional Application No. 61/008,141, entitled “Method for Authenticating the Contents of Electronic Mail via Outgoing Mail Server Using Unique Content Identifier,” filed Dec. 19, 2007. The subject matter of the related application is hereby incorporated by reference.

### FIELD OF THE INVENTION

The invention relates to authentication of electronic mail (email) messages and particularly to a system and method for content-based email authentication.

### BACKGROUND

Electronic mail (email) has become a ubiquitous form of communication, for both personal and professional correspondence. Important business deals are often conducted almost solely via email. Colleagues collaborating on a project may communicate with each other solely by email, and may exchange email correspondence that contains information that is confidential and proprietary to their employer. Many organizations use email for confidential communications without using any type of additional security, such a PGP (Pretty Good Privacy) encryption. PGP encryption requires an exchange of public keys by the sender and the recipient. Using such a key-based encryption technique is quite burdensome when sending an email to multiple recipients, so burdensome that it is rarely used.

While email enjoys widespread use and is generally a trusted form of communication, it is vulnerable to being intercepted or manipulated by unauthorized persons. It is possible to send an email message that appears to come from an email address other than the one from which the email was actually sent. For example, the well-known scam of “phishing” uses email messages that apparently are sent from a financial institution to entice the recipient to disclose his or her account information and password. There is often no way for a recipient to be completely sure that an email was indeed sent by the apparent sender, especially when the apparent sender is an institution instead of an individual.

Thus there is a need for a technique for email authentication that is not burdensome to the user.

### SUMMARY

One embodiment of a system of content-based email authentication includes an electronic mail server configured to receive an electronic mail message from a client and to send an electronic mail message to a network, a content identifier generator configured to generate at least one content identifier for an electronic mail message by applying a hash algorithm to content of the electronic mail message, the electronic mail server further configured to append the at least one content identifier to the electronic mail message before sending the electronic mail message. The electronic mail server is further configured to receive a second electronic mail message from a network, the second electronic mail message having at least one appended content identifier, the content identifier generator is further configured to generate at least one content identifier for the second electronic mail message, and the electronic mail server is further configured to compare the at least one content identifier for the second electronic email message with the at least one appended content identifier and if the at least one content identifier and the at least one appended content identifier match, the electronic mail server is configured to send the second electronic mail message to a client.

One embodiment of a method for content-based email authentication includes receiving an electronic mail message from a client, generating at least one content identifier for the electronic mail message by applying a hash algorithm to content of the electronic mail message, appending the at least one content identifier to the electronic mail message, and sending the electronic mail message with the appended at least one content identifier to a network.

One embodiment of a method for content-based email authentication includes receiving an electronic mail message from a network, the electronic mail message having at least one appended content identifier, generating at least one content identifier for the electronic mail message by applying a hash algorithm to content of the electronic mail message, comparing the generated at least one content identifier and the at least one appended content identifier; and if the generated at least one content identifier and the at least one appended content identifier match, sending the electronic mail message to a client.

### BRIEF DESCRIPTION OF THE DRAWINGS

FIG. 1 is a diagram of one embodiment of a computer network including email clients and email servers, according to the invention;

FIG. 2 is a flowchart of method steps for creating an outgoing email with a unique content identifier, according to one embodiment of the invention; and

FIG. 3 is a flowchart of method steps for authenticating an incoming email with a unique content identifier, according to one embodiment of the invention.

### DETAILED DESCRIPTION

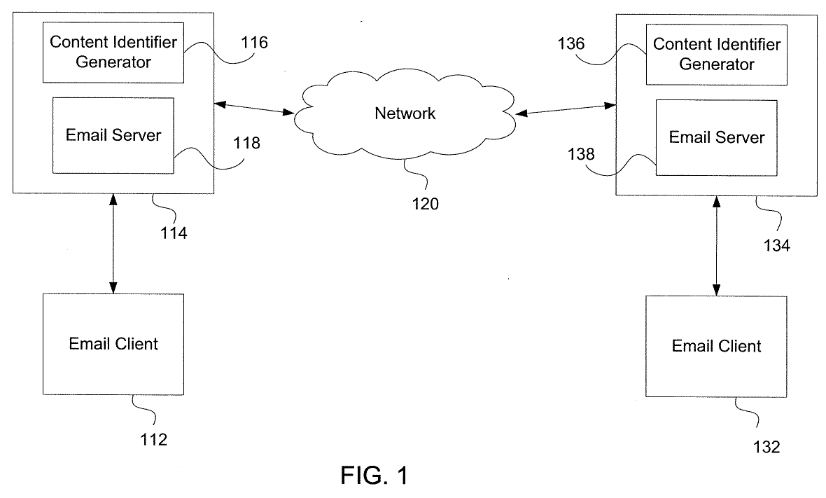

FIG. 1 is a diagram of one embodiment of a computer network including email clients and email servers, according to the invention. An email client 112 is communicatively coupled to a network node 114 that includes an email server 118 and a content identifier generator 116. Node 114 is communicatively coupled to a network 120, which is communicatively coupled to a network node 134. Network 120 may be any type of communication network such as a local area network or a wide area network, and may be wired, wireless, or a combination. Node 134 includes an email server 138 and a content identifier generator 136. An email client 132 is communicatively coupled to node 134.

Email client 112 is configured to enable a user to send and receive email messages. Email client 112 may be located on any type of general computing device, such as a desktop computer, a laptop computer, a workstation, or any type of handheld computing device such as a personal digital assistant, mobile phone, or smartphone. Email client 112 may alternately be located on a server such that a user accesses email client 112 via a web browser.

Email server 118 is configured to receive outgoing email messages from email clients such as email client 112. In one embodiment, email server 118 is configured to send and receive email messages using the simple mail transport protocol (SMTP). Email server 118 in conjunction with content identifier generator 116 creates authenticable outgoing email messages. Email server 118 uses content identifier generator 116 to generate a content identifier for the message header and for the message body of an email received from email client 112. If the email includes an attached file (attachment), content identifier generator 116 also generates a content identifier for the attached file. Content identifier generator 116 applies a hash algorithm to the content of the message header and message body to generate the content identifiers. In one embodiment, the hash algorithm is the well-known MD5 hash algorithm that produces a 128-bit number derived from the content; however any other hash algorithm, for example SHA-1, may be used to generate content identifiers so long as the probability of generating identical content identifiers for different content using that algorithm is below an acceptable threshold. In one embodiment, content identifier generator 116 generates a single content identifier for the email message, where the single content identifier is a hash of the content identifiers of the message header and the message body, and the content identifier of the attachment, if applicable. In another embodiment, content identifier generator 116 generates a single content identifier for the email message, where the hash algorithm is applied to the entire content of the email as a whole. When email server 118 sends an outgoing email message to network 120, email server 118 appends the content identifiers to the outgoing email message.

Email server 138 is configured to receive incoming email messages from network 120. In one embodiment, email server 138 is configured to send and receive email using the simple mail transport protocol (SMTP). Email server 138 separates an incoming email message from network 120 into its message header, message body, and attachment, if any. Email server 138 also locates any content identifiers appended to the incoming email message. Email server 138 then authenticates the email message by using content identifier generator 136 to generate content identifiers for the received email message and compares the generated content identifiers with the received content identifiers that were appended to the received email message. Content identifier generator 136 calculates content identifiers for the message header and message body of the received email message and any attachments. Content identifier generator 136 may also generate a single content identifier of the email message from the content identifiers for the separate portions of the email message. If the currently-generated content identifiers match the content identifiers that were appended to the email message, then email server 138 determines that the email message is authentic, i.e., that the email message was not modified while en route from email server 118. If the two sets of content identifiers do not match, the email message is not authenticated and is not sent to the intended recipient. In one embodiment, email server 138 sends an indication of delivery failure to email server 118.

Email server 138 sends an authenticated email message to its intended recipient, such as email client 132. In one embodiment, email server 138 also sends a representation of one or more of the content identifiers for the received email message to email client 132. Email client 132 can present the representations of the content identifiers to the user to indicate that the email message has been authenticated. In one embodiment the representation of a content identifier is a 26-character alphanumeric string derived from the content identifier. Other representations of a content identifier derived from the content identifier, such as an alphanumeric string or a graphical representation like a bar code, are within the scope of the invention.

In another embodiment, email server 118 provides a copy of the outgoing email message with its appended content identifiers to a content addressable storage system (not shown) for archiving. Content addressable storage (CAS) is a technique for storing electronic information that can be retrieved based on its content, not on its storage location. When information is stored in a CAS system, a content identifier created using a hash algorithm is linked to the information. The content identifier is then used to retrieve the information. The CAS system will store each portion of the email message linked to its corresponding content identifier. The CAS system can be located at node 114 or can be remote such that email server 118 sends the copy of the email message and its content identifiers to the CAS system over network 120.

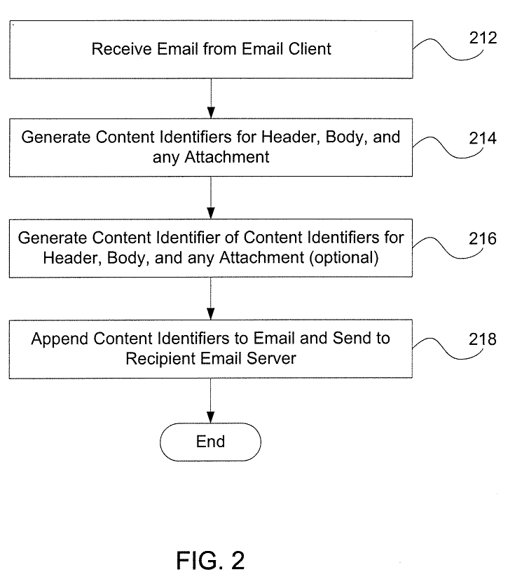

FIG. 2 is a flowchart of method steps for creating an outgoing email with a unique content identifier, according to one embodiment of the invention. In step 212, email server 118 receives an email from email client 112. In step 214, email server 118 uses content identifier generator 116 to generate content identifiers for the header and body of the email, and any attachments. The content identifiers are generated using a hash algorithm applied to the content of the header and the body of the email. In optional step 216, a single content identifier is generated for the email, where the single content identifier is a hash of the content identifiers for the components of the email. In another embodiment, a single content identifier is generated for the email by applying a hash algorithm to the entire content of the email as a whole. In step 218, email server 118 appends the content identifiers to the email and sends the email with appended content identifiers to the recipient email server identified in the email header. In another embodiment, email server 118 also sends a copy of the email with its appended content identifiers to a content addressable storage system for archiving.

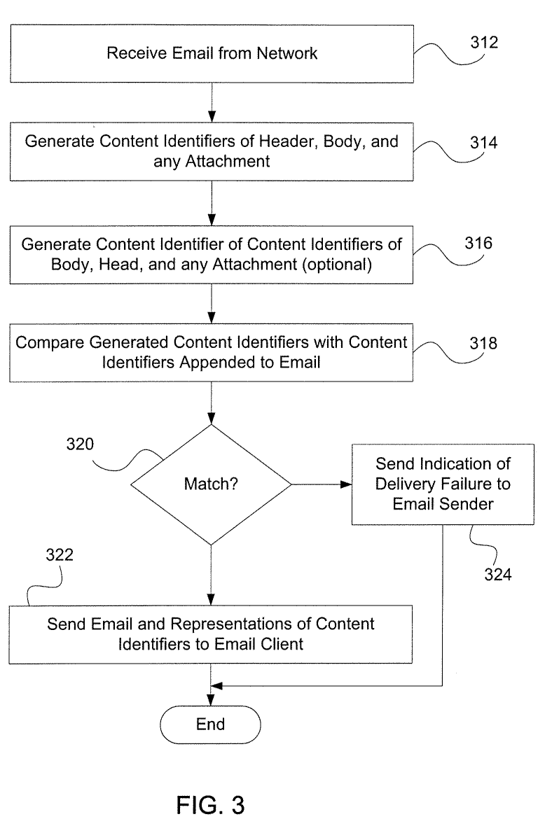

FIG. 3 is a flowchart of method steps for authenticating an incoming email with a unique content identifier, according to one embodiment of the invention. In step 312, an email server 138 receives an email from a network and separates the email into its components, including any attachments and appended content identifiers. In step 314, email server 138 uses content identifier generator 136 to generate content identifiers for the header and body of the email, and any attachments. The content identifiers are generated using a hash algorithm applied to the content of the header and body of the email. In optional step 316, a single content identifier is generated for the email, where the single content identifier is a has of the content identifiers for the components of the email. In another embodiment, a single content identifier is generated for the email by applying a hash algorithm to the entire content of the email as a whole.

In step 320, email server 138 compares the generated content identifiers with the content identifiers that were appended to the email. If the two sets of content identifiers match, then the method continues with step 322, where email server 138 sends the email and representations of the content identifiers to the recipient email client. The representations of the content identifiers indicate to a user of the recipient email client that the received email has been authenticated. In one embodiment the representation of a content identifier is a 26-character alphanumeric string derived from the content identifier. Other representations of a content identifier derived from the content identifier, such as an alphanumeric string or a bar code, are within the scope of the invention. If the two sets of content identifiers do not match, the method continues with step 324, where email server 138 sends an indication of delivery failure to the originating email server identified in the email header.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A system comprising:
an electronic mail server configured to receive an electronic mail message from a client and to send an electronic mail message to a network; and
a content identifier generator configured to generate at least one content identifier for an electronic mail message by applying a hash algorithm to content of the electronic mail message,
the electronic mail server further configured to append the at least one content identifier to the electronic mail message before sending the electronic mail message.

2. The system of claim 1, wherein the electronic mail message includes a message header and a body, and the content identifier generator is further configured to generate a first content identifier for the message header and a second content identifier for the body.

3. The system of claim 1, wherein the electronic mail message includes an attached file, and the content identifier generator is further configured to generate a content identifier for the attached file.

4. The system of claim 1, wherein the electronic mail server is further configured to receive a second electronic mail message from a network, the second electronic mail message having at least one appended content identifier, the content identifier generator is further configured to generate at least one content identifier for the second electronic mail message, and the electronic mail server is further configured to compare the at least one content identifier for the second electronic email message with the at least one appended content identifier and if the at least one content identifier and the at least one appended content identifier match, the electronic mail server is configured to send the second electronic mail message to a client.

5. The system of claim 4, wherein the electronic mail server is further configured to append a representation of the at least one content identifier to the second electronic mail message prior to sending the second electronic mail message to the client.

6. The system of claim 1, wherein the electronic mail server is further configured to provide a copy of the electronic mail message and a copy of the at least one content identifier to a content addressable storage system.

7. A method comprising:
receiving an electronic mail message from a client;
generating at least one content identifier for the electronic mail message by applying a hash algorithm to content of the electronic mail message;
appending the at least one content identifier to the electronic mail message; and
sending the electronic mail message with the appended at least one content identifier to a network.

8. The method of claim 7, wherein the electronic mail message include a message header and a body, and generating at least one content identifier for the electronic mail message includes generating a first content identifier for the message header and a second content identifier for the body.

9. The method of claim 7, wherein the electronic mail message includes an attached file, and generating at least one content identifier for the electronic mail message includes generating a content identifier for the attached file.

10. The method of claim 7, further comprising providing a copy of the electronic mail message and a copy of the at least one content identifier to a content addressable storage system.

11. A method comprising:
receiving an electronic mail message from a network, the electronic mail message having at least one appended content identifier;
generating at least one content identifier for the electronic mail message by applying a hash algorithm to content of the electronic mail message;
comparing the generated at least one content identifier and the at least one appended content identifier; and
if the generated at least one content identifier and the at least one appended content identifier match, sending the electronic mail message to a client.

12. The method of claim 11, wherein the electronic mail message include a message header and a body, and generating at least one content identifier for the electronic mail message includes generating a first content identifier for the message header and a second content identifier for the body.

13. The method of claim 11, wherein the electronic mail message includes an attached file, and generating at least one content identifier for the electronic mail message includes generating a content identifier for the attached file.

14. The method of claim 11, further comprising appending a representation of the at least one content identifier to the electronic mail message prior to sending the electronic mail message to the client.

15. The method of claim 11, further comprising:
if the generated at least one content identifier and the at least one appended content identifier do not match, sending a delivery failure notification to an originating electronic mail server.
